(19) United States
(12) Patent Application Publication
(10) Pub. No.: US 2020/0341639 A1
(43) Pub. Date: Oct. 29, 2020

(54) LATTICE LAYOUT OF REPLICATED DATA ACROSS DIFFERENT FAILURE DOMAINS

(71) Applicant: NetApp, Inc., Sunnyvale, CA (US)

(72) Inventor: Christopher Lee Cason, Boulder, CO (US)

(21) Appl. No.: 16/392,885

(22) Filed: Apr. 24, 2019

(51) Int. Cl. G06F 3/06; G06F 11/20; H04L 9/06; G06F 11/14

(52) U.S. Cl. CPC G06F 3/065; G06F 11/2094; G06F 3/0619; G06F 3/0611; G06F 11/1464; G06F 3/067; G06F 3/0644; H04L 9/0643; G06F 3/0631; G06F 3/064

(57) ABSTRACT

A technique organizes storage nodes of a cluster into failure domains logically organized vertically as protection domains of the cluster and stores replicas (i.e., one or more copies) of data (e.g., data block) on separate protection domains to ensure a replicated data layout such that a plurality of copies of a data block are resident at least on two or more different failure domains of nodes. An enhancement to the technique extends the layout of replicated data to include consideration of additional failure domains logically organized horizontally as replication zones of nodes storing the data. Each row (i.e., horizontal failure domain) is illustratively embodied as a “replication zone” that contains all replicas of the data block such that the blocks remain within the replication zone, i.e., no copies or replicas of data blocks are made between different replication zones. The enhanced technique organizes the replications zones orthogonal to the protection domains such that the replication zones are deployed (e.g., overlaid) across the plurality of protection domains in a manner that enhances the reliable and durable distribution of replicas of the data within nodes of the cluster. Thus, if an entire (vertical) protection domain of nodes fails or is lost, or if multiple nodes that are not in the same (horizontal) replication zone fail or are lost, then not all copies of the data are lost and the cluster is still operational and functional.

### BACKGROUND

### Technical Field

The present disclosure relates to storage nodes and, more specifically, to distribution of data for increased reliability to access the data, including metadata, among storage nodes configured to provide a distributed storage architecture of a cluster.

### Background Information

A plurality of storage nodes organized as a cluster may provide a distributed storage architecture configured to service storage requests issued by one or more clients of the cluster. The storage requests are directed to data stored on storage devices coupled to one or more of the storage nodes of the cluster. An implementation of the distributed storage architecture may provide reliability of data serviced by the storage nodes through data replication, e.g., two copies of data, wherein each copy or replica of the data is stored on a separate storage device of the cluster. However, such an implementation may be vulnerable to complete loss of the data replicas in the event of, e.g., a power failure of a storage node servicing the two storage devices storing the replicated data.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a plurality of storage nodes interconnected as a storage cluster;

FIG. 2 is a block diagram of a storage node;

FIG. 3 is a block diagram of a storage service of the storage node;

FIG. 4 illustrates a write path of the storage node;

FIG. 5 is a block diagram of an exemplary layout of data stored across the storage nodes of the cluster;

FIG. 6 is a block diagram of a first exemplary layout of data in accordance with an enhanced technique; and.

FIG. 7 is a block diagram of a second exemplary layout of data in accordance with the enhanced technique.

### OVERVIEW

The embodiments described herein are directed to a technique that organizes storage nodes of a cluster into failure domains logically organized vertically as columns of nodes (or groups of nodes) and stores replicas (i.e., one or more copies) of data (e.g., a data block) on separate columns (i.e., vertical failure domains) to ensure a replicated data layout such that a plurality of copies of a data block are resident at least on two or more different failure domains of nodes. Each vertical failure domain is illustratively embodied as a “protection domain” that shares an infrastructure (e.g., power supply, network switch) subject to possible failure. For example, the storage nodes of a protection domain may be contained within a chassis that may share an infrastructure, e.g., electrical power infrastructure, such that a failure of the infrastructure results in a failure of the storage nodes within the chassis. Thus, if an entire chassis or group of storage nodes is lost, there is still at least one other copy of the data block stored in at least one other chassis or group of nodes in the cluster. Advantageously, the technique obviates any single point of failure in the cluster to ensure reliable and durable data protection in the cluster.

An enhancement to the technique extends the layout of replicated data to include consideration of additional failure domains logically organized (i.e., grouped) horizontally as rows of nodes storing the data. Each row (i.e., horizontal failure domain) is illustratively embodied as a “replication zone” that contains all replicas of the data block such that the blocks remain within the replication zone, i.e., no copies or replicas of data blocks are made between different replication zones. Specifically, the enhanced technique organizes the replications zones orthogonal to the protection domains such that the replication zones are deployed (e.g., overlaid) across the plurality of protection domains in a manner that enhances the reliable and durable distribution of replicas of the data within nodes of the cluster. That is, the enhanced technique organizes the replication zones horizontally across the protection domains as a lattice layout such that each replication zone is associated with respective replicated data. Thus, if an entire (vertical) protection domain of nodes fails or is lost, or if multiple nodes that are not in the same (horizontal) replication zone fail or are lost, then not all copies of the data are lost and the cluster is still operational and functional. More specifically, the data is replicated across a plurality of failure domains within a zone of replication such that at least one copy of the data is available from a functioning failure domain of the replication zone, even if all remaining failure domains within the replication zone become unavailable (e.g., due to malfunction, misconfiguration, component failure, power failure and the like). Thus, for N copies (i.e., replicas) of the data, N−1 of those copies may become unavailable while at least one copy of the data remains available.

Notably, the additional failure domains may involve independent infrastructure subject to failure. For example, a first failure domain may include a chassis of a first group (i.e., set) of nodes sharing a power supply that is included within (i.e., a subset of) a second failure domain having a second set of nodes across a group of chassis' within a rack that share, e.g., a power distribution infrastructure which may fail. Thus, a first replication zone configured to protect the first set of nodes may be different from a second replication zone configured to protect the second set of nodes. In this manner, the notion of a protection domain may be extended hierarchically from a chassis to an entire data center such that each level in the hierarchy subsumes (i.e., encompasses) a subordinate protection domain in the hierarchy; to wit, a set of nodes in a chassis sharing a power supply, another set of nodes in multiple chassis' within a rack that share a power infrastructure, another set of nodes in a group of racks sharing a high-throughput network switch, another set of nodes on a floor of a data center, and another set of nodes in an entire data center (e.g., to protect against environmental catastrophe, such as earth quakes). As a result, a hierarchy of replication zones may be needed where nodes (and duplicates) may be shared between replication zones, but that within any replication zone duplicates are made across the protection domains of that zone.

### DESCRIPTION

Storage Cluster

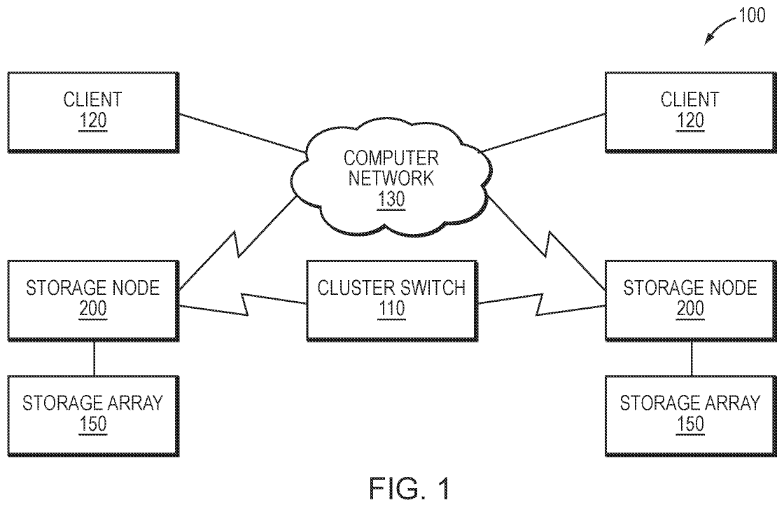

FIG. 1 is a block diagram of a plurality of storage nodes 200 interconnected as a storage cluster 100 and configured to provide storage service for information, i.e., data and metadata, organized and stored on storage devices of the cluster. The storage nodes 200 may be interconnected by a cluster switch 110 and include functional components that cooperate to provide a distributed, scale-out storage architecture of the cluster 100. The components of each storage node 200 include hardware and software functionality that enable the node to connect to and service one or more clients 120 over a computer network 130, as well as to a storage array 150 of storage devices, to thereby render the storage service in accordance with the distributed storage architecture.

Each client 120 may be embodied as a general-purpose computer configured to interact with the storage node 200 in accordance with a client/server model of information delivery. That is, the client 120 may request the services of the node 200, and the node may return the results of the services requested by the client, by exchanging packets over the network 130. The client may issue packets including file-based access protocols, such as the Network File System (NFS) and Common Internet File System (CIFS) protocols over the Transmission Control Protocol/Internet Protocol (TCP/IP), when accessing information on the storage node in the form of storage objects, such as files and directories. However, in an embodiment, the client 120 illustratively issues packets including block-based access protocols, such as the Small Computer Systems Interface (SCSI) protocol encapsulated over TCP (iSCSI) and SCSI encapsulated over FC (FCP), when accessing information in the form of storage objects such as logical units (LUNs).

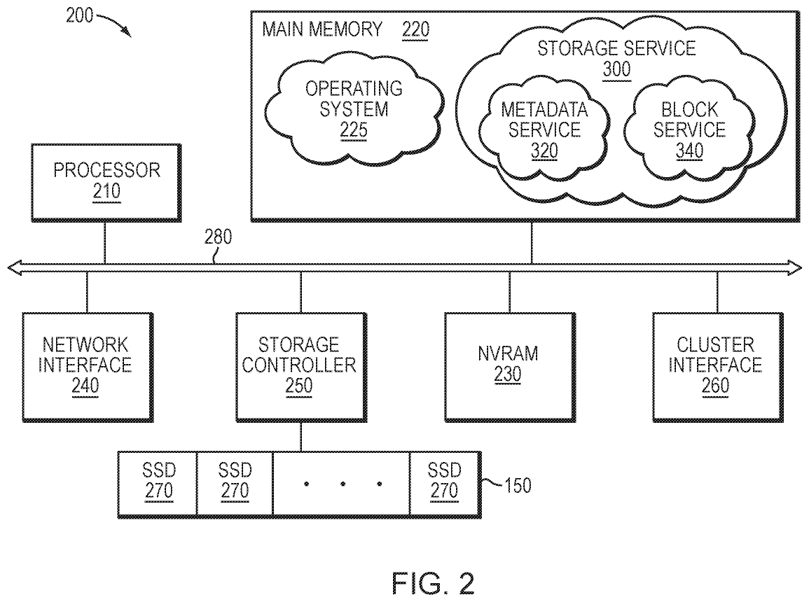

FIG. 2 is a block diagram of storage node 200 illustratively embodied as a computer system having one or more processing units (processors) 210, a main memory 220, a non-volatile random access memory (NVRAM) 230, a network interface 240, one or more storage controllers 250 and a cluster interface 260 interconnected by a system bus 280. The network interface 240 may include one or more ports adapted to couple the storage node 200 to the client(s) 120 over computer network 130, which may include point-to-point links, wide area networks, virtual private networks implemented over a public network (Internet) or a shared local area network. The network interface 240 thus includes the mechanical, electrical and signaling circuitry needed to connect the storage node to the network 130, which may embody an Ethernet or Fibre Channel (FC) network.

The main memory 220 may include memory locations that are addressable by the processor 210 for storing software programs and data structures associated with the embodiments described herein. The processor 210 may, in turn, include processing elements and/or logic circuitry configured to execute the software programs, such as metadata service 320 and block service 340 of storage service 300, and manipulate the data structures. An operating system 225, portions of which are typically resident in memory 220 (in-core) and executed by the processing elements (e.g., processor 210), functionally organizes the storage node by, inter alia, invoking operations in support of the storage service 300 implemented by the node. A suitable operating system 225 may include a general-purpose operating system, such as the UNIX® series or Microsoft Windows® series of operating systems, or an operating system with configurable functionality such as microkernels and embedded kernels. However, in an embodiment described herein, the operating system is illustratively the Linux® operating system. It will be apparent to those skilled in the art that other processing and memory means, including various computer readable media, may be used to store and execute program instructions pertaining to the embodiments herein.

The storage controller 250 cooperates with the storage service 300 implemented on the storage node 200 to access information requested by the client 120. The information is preferably stored on storage devices such as solid state drives (SSDs) 270, illustratively embodied as flash storage devices, of storage array 150. In an embodiment, the flash storage devices may be block-oriented devices (i.e., drives accessed as blocks) based on NAND flash components, e.g., single-layer-cell (SLC) flash, multi-layer-cell (MLC) flash or triple-layer-cell (TLC) flash, although it will be understood to those skilled in the art that other block-oriented, non-volatile, solid-state electronic devices (e.g., drives based on storage class memory components) may be advantageously used with the embodiments described herein. The storage controller 250 may include one or more ports having I/O interface circuitry that couples to the SSDs 270 over an I/O interconnect arrangement, such as a conventional serial attached SCSI (SAS), serial ATA (SATA) topology, and Peripheral Component Interconnect (PCI) express.

The cluster interface 260 may include one or more ports adapted to couple the storage node 200 to the other node(s) of the cluster 100. In an embodiment, dual 10 Gbps Ethernet ports may be used for internode communication, although it will be apparent to those skilled in the art that other types of protocols and interconnects may be utilized within the embodiments described herein. The NVRAM 230 may include a back-up battery or other built-in last-state retention capability (e.g., non-volatile semiconductor memory such as storage class memory) that is capable of maintaining data in light of a failure to the storage node and cluster environment.

Storage Service

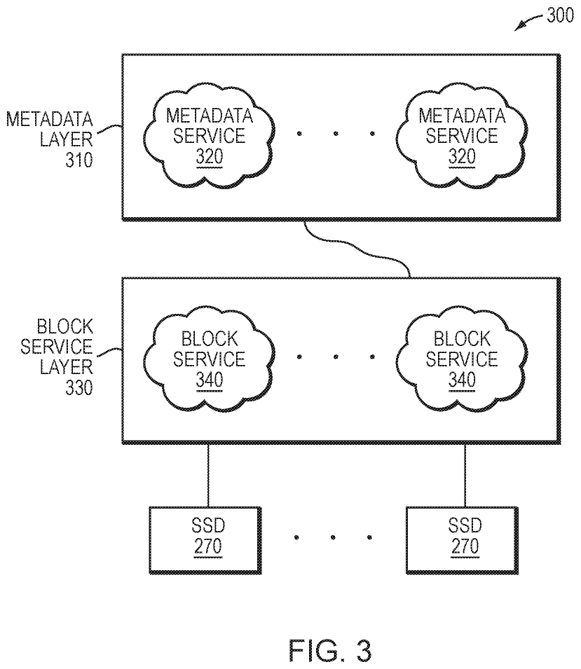

FIG. 3 is a block diagram of the storage service 300 implemented by each storage node 200 of the storage cluster 100. The storage service 300 is illustratively organized as one or more software modules or layers that cooperate with other functional components of the nodes 200 to provide the distributed storage architecture of the cluster 100. In an embodiment, the distributed storage architecture aggregates and virtualizes the components (e.g., network, memory, and compute resources) to present an abstraction of a single storage system having a large pool of storage, i.e., all storage arrays 150 of the nodes 200 for the entire cluster 100. In other words, the architecture consolidates storage, i.e., the SSDs 270 of the arrays 150, throughout the cluster to enable storage of the LUNs, which are apportioned into logical volumes (“volumes”) having a logical block size, such as 4096 bytes (4 KB) and 512 bytes. The volumes are further configured with properties such as size (storage capacity) and performance settings (quality of service), as well as access control, and are thereafter accessible as a block storage pool to the clients, preferably via iSCSI and/or FCP. Both storage capacity and performance may then be subsequently “scaled out” by growing (adding) network, memory and compute resources of the nodes 200 to the cluster 100.

Each client 120 may issue packets as input/output (I/O) requests, i.e., storage requests, to a storage node 200, wherein a storage request may include data for storage on the node (i.e., a write request) or data for retrieval from the node (i.e., a read request), as well as client addressing in the form of a logical block address (LBA) or index into a volume based on the logical block size of the volume and a length. The client addressing may be embodied as metadata, which is separated from data within the distributed storage architecture, such that each node in the cluster may store the metadata and data on different storage devices (SSDs 270) of the storage array 150 coupled to the node. To that end, the storage service 300 implemented in each node 200 includes a metadata layer 310 having one or more metadata services 320 configured to process and store the metadata, and a block server layer 330 having one or more block services 340 configured to process and store the data, e.g., on the SSDs 270. For example, the metadata service 320 maps between client addressing (e.g., LBA indexes) used by the clients to access the data on a volume and block addressing (e.g., block identifiers) used by the block services 340 to store the data on the volume, e.g., of the SSDs.

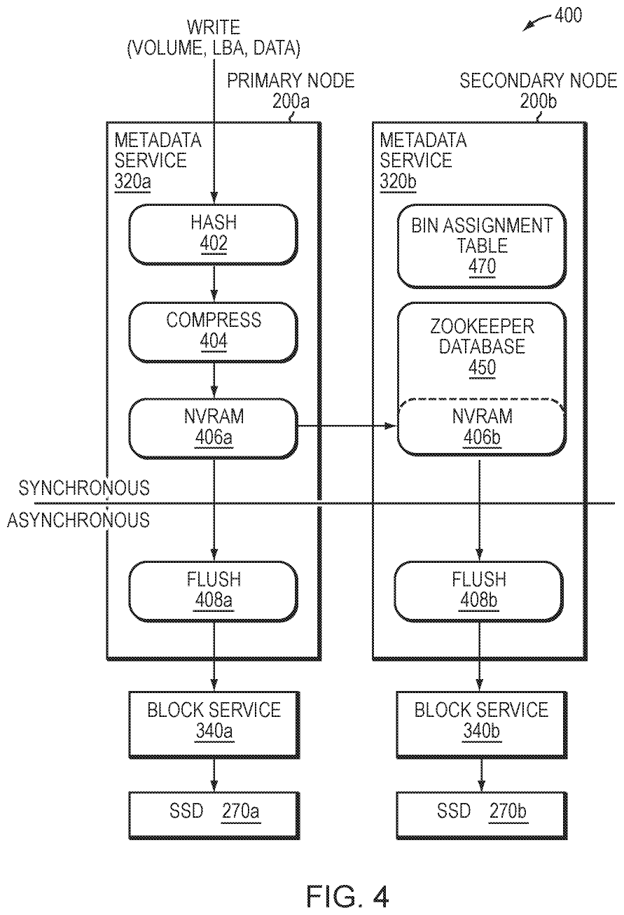

FIG. 4 illustrates a write path 400 of a storage node 200 for storing data on a volume of a storage array 150. In an embodiment, an exemplary write request issued by a client 120 and received at a storage node 200 (e.g., primary node 200a) of the cluster 100 may have the following form:
write (volume, LBA, data)

wherein the volume specifies the logical volume to be written, the LBA is the logical block address to be written, and the data is a logical block size of data to be written. Illustratively, the data received by a metadata service 320a of the storage node 200a is divided into 4 KB block sizes. At box 402, each 4 KB data block is hashed using a conventional cryptographic hash function to generate a 128-bit (16B) hash value (recorded as a block identifier (ID) of the data block); illustratively, the block ID is used to address (locate) the data on the storage array 150. A block ID is thus an identifier of a data block that is generated based on the content of the data block. The conventional cryptographic hash function, e.g., Skein algorithm, provides a satisfactory random distribution of bits within the 16B hash value/block ID employed by the technique. At box 404, the data block is compressed using a conventional, e.g., LZW (Lempel-Zif-Welch), compression algorithm and, at box 406a, the compressed data block is stored in NVRAM 230. Note that, in an embodiment, the NVRAM 230 is embodied as a write cache. Each compressed data block is then synchronously replicated to the NVRAM 230 of one or more additional storage nodes (e.g., secondary storage node 200b) in the cluster 100 for data protection (box 406b). An acknowledgement is returned to the client when the data block has been safely and persistently stored in the NVRAM 230 of the multiple storage nodes 200 of the cluster 100.

The embodiments described herein are directed to a technique that organizes the storage nodes 200 of the cluster 100 into failure domains logically organized vertically as columns of nodes and stores replicas (i.e., one or more copies) of data (e.g., data blocks) on separate columns (i.e., vertical failure domains) to ensure a replicated data layout such that a plurality of copies of a data block are resident at least on two or more different failure domains of nodes. Each vertical failure domain is illustratively embodied as a “protection domain” that shares an infrastructure subject to possible failure. For example, the storage nodes of a protection domain may be contained within a chassis that may share an infrastructure, e.g., electrical power infrastructure, such that a failure of the infrastructure results in a failure of the storage nodes within the chassis. That is, the storage nodes are physically arranged in vertical metal structures or “chassis” that enclose, inter alia, backplane, cables and power supplies configured to provide power to the nodes. Thus, if an entire chassis or group of storage nodes is lost, there is still at least one other copy of the data block stored in at least one other chassis or group of nodes in the cluster. Advantageously, the technique obviates any single point of failure in the cluster 100 to ensure reliable and durable data protection in the cluster.

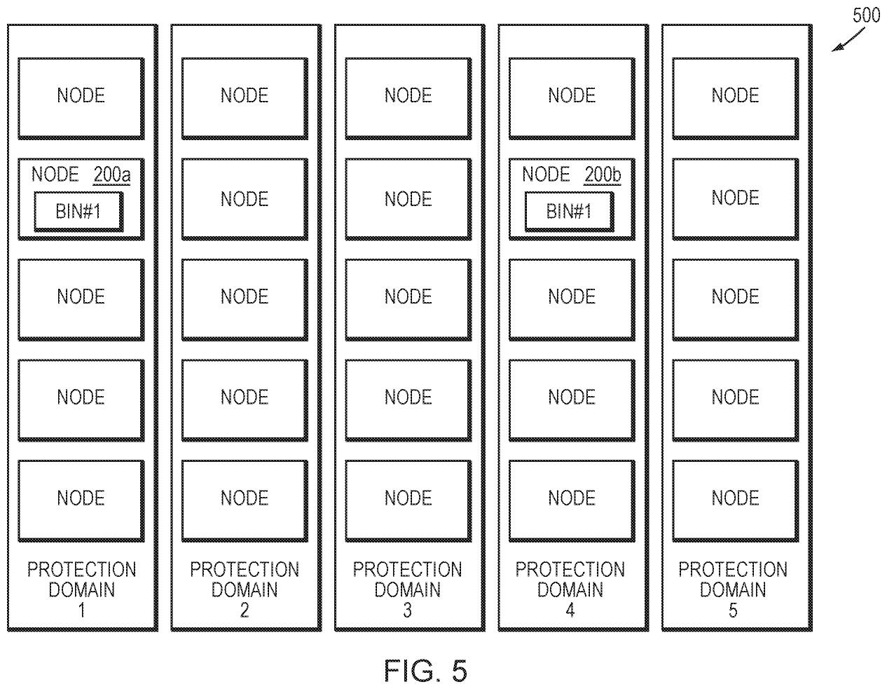

FIG. 5 is a block diagram of an exemplary layout 500 of data stored across the storage nodes of the cluster. Note that for simplicity/clarity of depiction and description, the data layout 500 in the cluster is shown in the context of storage nodes 200 rather than as SSDs 270 of storage array 150 coupled to the nodes. According to the technique, a “bin” is derived from the block ID, i.e., 16B hash value, for storage of a corresponding data block on a node/SSD by extracting a predefined number of bits from the block ID. In an embodiment, the first two bytes (2B) of the block ID are used to generate a bin number (“bin #”) between 0 and 65,535 (16-bits) that identifies a bin for storing the data block, and the resulting bin # is used in a mapping of two or more bins on SSDs 270 of two or more storage nodes 200 in the cluster 100 that store the data block. Bins may be distributed across the cluster according to (e.g., in proportion to) a relative storage capacity of the nodes, i.e., a storage node having twice an amount of storage capacity may be assigned twice as many bins. For example, two bins (identified by bin #1) may be stored on two, different storage nodes 200a,b (and, more specifically, two different SSDs 270) in the cluster 100. Moreover, mapping rules ensure that no two same numbered bins are stored on the same vertical failure domain (protection domain) of nodes. Thus, bins #1 are stored on nodes 200a,b of different protection domains 1,4. Illustratively, the above mapping occurs in connection with “bin assignments” where the bin numbers are assigned to all SSDs 270 in the cluster 100.

According to the technique, the block ID (hash value) is used to distribute the data blocks among bins in an evenly balanced (distributed) arrangement according to capacity of the SSDs, wherein the balanced arrangement is based on “coupling” between the SSDs, i.e., each node/SSD is assigned an approximately the same number of bins with any other node/SSD that is not in the same protection domain. This is advantageous for rebuilding data in the event of a failure (i.e., rebuilds) so that all SSDs perform approximately the same amount of work (e.g., reading/writing data) to enable fast and efficient rebuild by distributing the work equally among all the SSDs of the storage nodes of the cluster.

In an embodiment, the data is persistently stored in a distributed key-value store, where the block ID of the data block is the key and the compressed data block is the value. This abstraction provides global data deduplication of data blocks in the cluster. Referring again to FIG. 4, the distributed key-value store may be embodied as, e.g., a “zookeeper” database 450 configured to provide a distributed, shared-nothing (i.e., no single point of contention and failure) database used to store configuration information that is consistent across all nodes of the cluster. The zookeeper database 450 is further employed to store a mapping between an ID of each SSD and the bin number of each bin, e.g., SSD ID-bin number. Each SSD has a service/process associated with the zookeeper database 450 that is configured to maintain the mappings in connection with a data structure, e.g., bin assignment table 470. Illustratively the distributed zookeeper database is resident on up to, e.g., five (5) selected nodes in the cluster, wherein all other nodes connect to one of the selected nodes to obtain the mapping information. Thus, these selected “zookeeper” nodes have replicated zookeeper database images distributed among different failure domains of nodes in the cluster so that there is no single point of failure of the zookeeper database. In other words, other nodes issue zookeeper requests to their nearest zookeeper database image (zookeeper node) to obtain current mappings, which may then be cached at the nodes to improve access times.

For each data block received and stored in NVRAM 230, the metadata services 320a,b compute a corresponding bin number and consult the bin assignment table 470 to identify the two SSDs 270a,b to which the data block is written. At boxes 408a,b, the metadata services 320a,b of the storage nodes 200a,b then issue store requests to asynchronously flush a copy of the compressed data block to the block services 340a,b associated with the identified SSDs. An exemplary store request issued by each metadata service 320 and received at each block service 340 may have the following form:
store (block ID, compressed data)

The block service 340a,b for each SSD 270a,b determines if it has previously stored a copy of the data block. If not, the block service 340a,b stores the compressed data block associated with the block ID on the SSD 270a,b. Note that the block storage pool of aggregated SSDs is organized by content of the block ID (rather than when data was written or from where it originated) thereby providing a “content addressable” distributed storage architecture of the cluster. Such a content-addressable architecture facilitates deduplication of data “automatically” at the SSD level (i.e., for “free”), except for at least two copies of each data block stored on at least two SSDs of the cluster. In other words, the distributed storage architecture utilizes a single replication of data with inline deduplication of further copies of the data, i.e., there are at least two copies of data for redundancy purposes in the event of unavailability of some copies of the data (e.g., due to malfunction, misconfiguration, hardware failure, power failure, cable pull, and the like). Thus for N copies (i.e., replicas) of the data, N−1 of those copies may become unavailable while at least one copy of the data remains available.

In addition to ensuring a data layout of the cluster wherein no two copies of the data are resident on one protection domain (vertical failure domain) of nodes (i.e., enforced by the bin mapping rules), an enhancement to the technique extends the layout of replicated data to include consideration of additional failure domains logically organized horizontally as rows of nodes storing the data. Each row (i.e., horizontal failure domain) is illustratively embodied as a “replication zone” that contains all replicas of the data block such that the blocks remain within the replication zone, i.e., no copies or replicas of data blocks are made between different replication zones. Specifically, the enhanced technique organizes the replications zones orthogonal to the protection domains such that the replication zones are deployed (e.g., overlaid) across the plurality of protection domains in a manner that enhances the reliable and durable distribution of replicas (e.g., two copies) of the data within nodes of the cluster. That is, the enhanced technique organizes the replication zones horizontally across the protection domains as a lattice layout such that each replication zone is associated with respective replicated data. Thus, if an entire (vertical) protection domain of nodes fails or is lost, or if multiple nodes that are not in the same (horizontal) replication zone fail or are lost, then not all copies of the data are lost and the cluster is still operational and functional. Thus for N copies (i.e., replicas) of the data, N−1 of those copies may become unavailable while at least one copy of the data remains available.

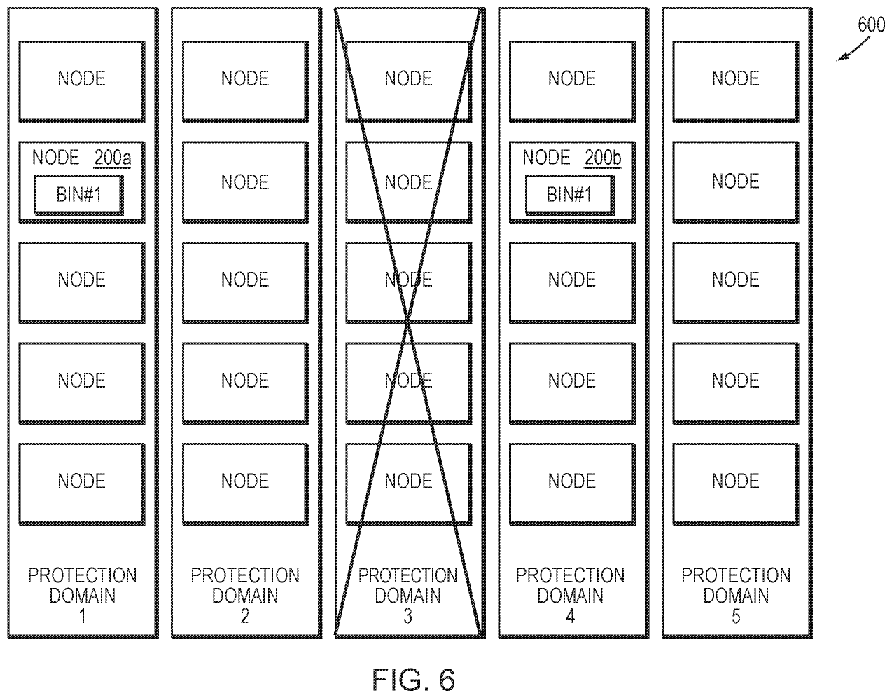

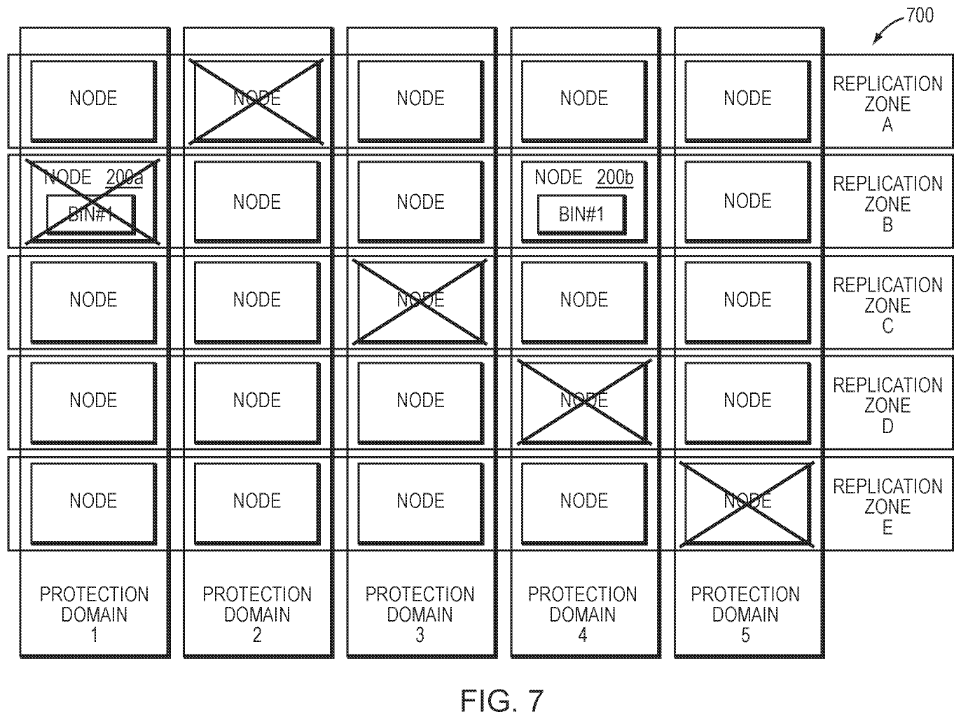

Illustratively, the enhanced technique organizes the 65,536 bins of the cluster into virtual clusters embodied as horizontal failure domains or “replications zones” and vertical failure domains or “protection domains” of bins to enable deployment of a finer granularity of replication by assigning and distributing data blocks among the bins of the replication zones and protection domains to ensure reliable and durable protection of data in the cluster. FIG. 6 is a block diagram of a first exemplary layout of data in accordance with the enhanced technique. Despite failure or loss of an entire protection domain, e.g., protection domain 3, of nodes as illustrated in FIG. 6, not all copies of the data are lost and the cluster is still operational and functional. Note that failure of the protection domain in accordance with the enhanced technique is dependent on the randomness of node/SSD failures outside of the failed protection domain. FIG. 7 is a block diagram of a second exemplary layout of data in accordance with the enhanced technique. Here, failure or loss of multiple nodes/SSDs not in the same (horizontal) replication zone, e.g., nodes within replication zones A-E is illustrated; yet not all copies of the data are lost and the cluster is still operational and functional. According to the enhanced technique, all replicas of bin #1 are wholly contained within replication zone B and, further, all replicas of bin #1 are not contained with the same protection domain 1 or 4.

In sum, all replicas of a bin are contained in the same replication zone, such that a replication zone includes N replicas (copies) of a bin, i.e., all replicas (N) of the bin are included in the replication zone. Thus, the cluster can lose up to N−1 protection domain copies within (i.e., underlying) a replication zone and still be operational/functional (i.e., no data loss). In addition, the cluster can withstand up to N−1 complete protection domain losses and still have a replica/copy of the data/bin. That is, up to N−1 protection domains can be completely lost (FIG. 6) or up to N−1 nodes within each replication zone can be lost (FIG. 7) and the cluster will still maintain at least one copy/replica of the data block.

Once a failure has been deemed permanent, the bin assignments may be reconfigured and data may be moved from an existing bin location to a new bin location to thereby re-establish two copies of the data in the cluster. Ideally, additional free storage space (e.g., within a chassis) may be reserved for failure of a protection domain (e.g., chassis); otherwise, healing (automatically or otherwise) may not be possible. Even if free storage space is reserved, there may be times when that storage space is partially (or even fully) consumed with data; the data may then be moved to different bin locations throughout the cluster. Note that data unavailability may be due to temporary failure such as node reboots or power cycling, cable pulls and power failure.

Advantageously, the enhanced technique provides a lattice layout of replicated data within bins of different storage nodes that enables the cluster to sustain failure of nodes grouped as different failure domains (i.e., protection domains and replication zones) of the cluster. These groupings of data are “points of failures” that may be prone to failure because of, e.g., the physical architecture (how the nodes/SSDs are physically wired and organized) in a data center cluster. Accordingly, the bins/data are laid out across such failure points/domains.

Since there is potentially a large number of SSDs available in the cluster for storing replicated data (i.e., a second copy of data), the particular protection domain and replication zone that is selected and that contains the SSD used for the replicated (second copy) of the data becomes an important determination. In an embodiment, data is replicated according to placement rules or constraints for where to locate the second, replicated copy of data for redundancy to increase reliability. There is also at least one “desirable,” e.g., performance, characteristic that is considered. As such, the placement of replicated data includes the placement rules for redundancy and the performance characteristic to improve, e.g., latency and load on the storage nodes. The placement rules include (1) the same bin may not be located in the same protection domain (or chassis) and (2) only a subset of the bins may be located in any replication zone of the cluster. The desirable characteristic includes (3) evenly distributing the coupling/interconnection between the storage nodes and SSDs sharing the bins within any replication zone to improve load sharing among the storage nodes. Therefore, the load (both storage and processing wise) may be distributed across the SSDs in accordance with the conventional hashing function used for assignment of the bins. For example, in the case of N replicas where N=2, no protection domain may have more than one copy of the data and no replication zone may have more than two copies of that data.

Operationally, each time a 4 KB data block of a write request is generated and hashed at a storage node, the first two bytes of the hash value is checked (e.g., looked up in the bin assignment table 470) to determine the bin number which, in turn, identifies the two block services 340 to which the data is forwarded for storage. For a read operation or request, the block ID is parsed to determine the bin number for look-up in the table 470 to determine the two block services from which the data may be retrieved. A choice therefore may be rendered from which block service to read the data utilizing various other techniques that minimize latency and/or balance the load. That is, a block service that is selected from among the block services from which the data may be retrieved may be based on load balancing the storage nodes and controlling latency to the storage nodes.

As noted the first two bytes of the block ID (the bin number) are used for an addressing scheme to determine which SSD stores the data. The bin numbers are assigned according to a mapping to each SSD hosting the data; the assignment is fixed within the cluster and is only changed at configuration (e.g., adding/removing storage nodes and SSDs or encountering failures). At this time, the mapping may change but once changed, it is fixed (e.g., a particular block of data is mapped to a particular SSD based on the assignment).

While there have been shown and described illustrative embodiments of a technique that provides a lattice layout of replicated data within bins of different storage nodes to enable a cluster to sustain failure of nodes grouped as different failure domains of the cluster, it is to be understood that various other adaptations and modifications may be made within the spirit and scope of the embodiments herein. For example, embodiments have been shown and described herein with relation to failure domains logically organized vertically as protection domains configured to store replicas (i.e., one or more copies) of data (e.g., data blocks) such that copies of a data block are resident at least on two or more different protection domains of nodes. Because of the bin mapping rule that prevents assignment of two same numbered bins to a single protection domain, no two copies of the data block are resident on one protection domain of nodes. Additional failure domains are logically organized horizontally as replication zones overlaid across the protection domains, wherein all replicas of each data block are restricted to a respective one of the replication zones, i.e., blocks are not copied across different replication zones, but stay within the respective replication zone.

However, the embodiments in their broader sense are not so limited, and may, in fact, allow for extended virtualization of logical constructs involving the failure domains of the cluster. Here, the additional failure domains may involve independent infrastructure subject to failure. For example, a first failure domain may include a chassis of a first group (i.e., set) of nodes sharing a power supply that is included within (i.e., a subset of) a second failure domain having a second set of nodes across a group of chassis' within a rack that share, e.g., a power distribution infrastructure which may fail. Thus, a first replication zone configured to protect the first set of nodes may be different from a second replication zone configured to protect the second set of nodes depending on the protection domain, i.e., protection against a type of unavailability usually associated with hardware failure (cable failure, switch failure, power failure). In this manner, the notion of a failure domain may be extended hierarchically from a chassis to an entire data center, i.e., a protection domain and/or replication zone hierarchy such that each level in the hierarchy subsumes (i.e., encompasses) a subordinate protection domain in the hierarchy.

For instance, assume that, at a lowest level of failure domain virtualization, a node may represent a logical construct embodied as a protection domain (PD). The virtualization may then be extended at a next higher level wherein a chassis of nodes may represent the PD. Such virtualization may be further extended such that a rack of multiple chassis may represent the PD, followed by a data center of multiple racks representing the PD. More specifically, the extended hierarchy of failure domain virtualization may include a set of nodes in a chassis sharing a power supply, another set of nodes in multiple chassis' within a rack that share a power infrastructure, another set of nodes in a group of racks sharing a high-throughput network switch, another set of nodes on a floor of a data center, and another set of nodes in an entire data center (e.g., to protect against environmental catastrophe, such as earth quakes). As a result, a hierarchy of replication zones may be configured where nodes (and duplicates) may be shared between replication zones, but that within any replication zone duplicates are made across the protection domains of that zone.

An additional enhancement may further extend the technique based on a type of information, i.e., metadata and data, stored in the cluster such that different protection domains (and thus different replication zones) may be applied to each type of information. Thus, in an embodiment, cluster metadata may be replicated according to a first protection domain hierarchy and cluster data may be replicated according to a second protection domain hierarchy different from the first protection domain hierarchy, even though much of the two hierarchies may be shared.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks, electronic memory, and/or CDs) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
organizing a cluster of storage nodes each having a storage device into a plurality of protection domains, each protection domain including one or more of the storage nodes, wherein each protection domain is a point of failure for the storage nodes within the respective protection domain;
mapping bins to the storage nodes, the bins having a value based on a first portion of a cryptographic hash of data blocks such that no two bins having a same value are mapped to a same protection domain; and
replicating the data blocks among the mapped bins such that a plurality of copies of a data block are resident at least on two or more different protection domains so that when a protection domain is unavailable, the data is recoverable from one or more available protection domains.

2. The method of claim 1 further comprising:
organizing one or more replication zones orthogonal to the protection domains such that the replication zones are deployed across the plurality of protection domains, wherein all replicas of each data block are restricted to a respective one of the replication zones.

3. The method of claim 1 further comprising:
organizing the storage nodes of the cluster vertically into the protection domains; and
organizing the replication zones horizontally across the protection domains as a lattice layout such that each replication zone is associated with respective replicated data.

4. The method of claim 1 further comprising:
organizing one or more bins as a subset of the cluster into a virtual cluster, wherein the data blocks are distributed among the nodes of the virtual cluster based on a second portion of the cryptographic hash.

5. The method of claim 1 wherein replicating the data among the protection domains for each replication zone is performed to load balance access requests across the respective replication zone.

6. The method of claim 1 wherein replicating the data among the protection domains for each replication zone is performed to control latency for access requests across the respective replication zone.

7. The method of claim 4 wherein an approximately same number of bins is assigned to any node not in a same protection domain.

8. The method of claim 1 wherein each protection domain shares an infrastructure common to the storage nodes of the respective protection domain.

9. The method of claim 1 wherein replicating data among the protection domains for each replication zone is performed according to placement rules to enhance redundancy and a performance characteristic to enhance load sharing among the storage nodes.

10. The method of claim 1 wherein a number of bins is assigned to each node in proportion to a relative storage capacity of the respective node.

11. A system comprising:
a cluster of storage nodes each having a processor coupled to a storage device, each node including program instructions executing on the processor, the program instructions configured to:
organize the cluster into a plurality of protection domains, each protection domain including one or more of the storage nodes, wherein each protection domain is a point of failure for the storage nodes within the respective protection domain;
map bins to the storage nodes, the bins having a value based on a first portion of a cryptographic hash of data blocks such that no two bins having a same value are mapped to a same protection domain; and
replicate the data blocks among the mapped bin such that a plurality of copies of a data block are resident at least on two or more different protection domains so that when a protection domain is unavailable, the data is recoverable from one or more available protection domains.

12. The system of claim 11 wherein the program instructions are further configured to:
organize one or more replication zones orthogonal to the protection domains such that the replication zones are deployed across the plurality of protection domains, wherein all replicas of each data block are restricted to a respective one of the replication zones.

13. The system of claim 11 wherein the program instructions are further configured to:
organize the storage nodes of the cluster vertically into the protection domains; and
organize the replication zones horizontally across the protection domains as a lattice layout such that each replication zone is associated with respective replicated data.

14. The system of claim 11 wherein the program instructions are further configured to:
organize one or more bins as a subset of the cluster into a virtual cluster, wherein the data blocks are distributed among the nodes of the virtual cluster based on a second portion of the cryptographic hash.

15. The system of claim 11 wherein replicating the data among the protection domains for each replication zone is performed to load balance access requests across the respective replication zone.

16. The system of claim 11 wherein replicating the data among the protection domains for each replication zone is performed to control latency for access requests across the respective replication zone.

17. The system of claim 14 wherein an approximately same number of bins is assigned to any node having a same storage capacity that is not in a same protection domain.

18. The system of claim 14 wherein each protection domain shares an infrastructure common the storage nodes of the respective protection domain.

19. The system of claim 11 wherein replicating data among the protection domains for each replication zone is performed according to placement rules to enhance redundancy and a performance characteristic to enhance load sharing among the storage nodes.

20. A non-transitory computer readable medium including program instructions for execution on a processor included on each storage node of a cluster, the program instructions configured to:
organize the cluster into a plurality of protection domains, each protection domain including one or more of the storage nodes, wherein each protection domain is a point of failure for the storage nodes within the respective protection domain;
map bins to the storage nodes, the bins having a value based on a first portion of a cryptographic hash of data blocks such that no two bins having a same value are mapped to a same protection domain; and
replicate the data blocks among the mapped bin such that a plurality of copies of a data block are resident at least on two or more different protection domains so that when a protection domain is unavailable, the data is recoverable from one or more available protection domains.
